(19) United States
(12) Patent Application Publication
(10) Pub. No.: US 2024/0368005 A1
(43) Pub. Date: Nov. 7, 2024

(54) THERMAL POWER PLANT SEAWATER DESALINATION AND LITHIUM EXTRACTION SYSTEM AND METHOD

(71) Applicant: China Huaneng Group Clean Energy Technology Research Institute Co., Ltd, Beijing (CN)

(72) Inventors: Yusen YANG, Beijing (CN); Weidong LI, Beijing (CN); Libing REN, Beijing (CN); Shuai ZHANG, Beijing (CN)

(73) Assignee: China Huaneng Group Clean Energy Technology Research Institute Co., Ltd, Beijing (CN)

(21) Appl. No.: 18/756,823

(22) Filed: Jun. 27, 2024

Related U.S. Application Data
(63) Continuation of application No. PCT/CN2022/139188, filed on Dec. 15, 2022.

(30) Foreign Application Priority Data
Dec. 28, 2021 (CN) 2021116293500

(51) Int. Cl. C02F 1/46; C02F 1/469; C02F 101/10; C02F 103/08

(52) U.S. Cl. CPC C02F 1/4604; C02F 1/4693; C02F 2101/10; C02F 2103/08; C02F 2201/46165

(57) ABSTRACT

The present application provides a thermal power plant seawater desalination and lithium extraction system, including a seawater desalination apparatus and a seawater lithium extraction apparatus. The seawater desalination apparatus is connected to a power supply of a thermal power plant or a peak load and frequency regulation power supply line, so that the seawater desalination apparatus is supplied with power through surplus power of the thermal power plant; the seawater desalination apparatus is connected to a turbine extraction steam system of the thermal power plant, so that heat is supplied to the seawater desalination apparatus through the turbine extraction steam system; the seawater lithium extraction apparatus is connected to the seawater desalination apparatus, so that concentrated seawater generated in a process of desalinating seawater by the seawater desalination apparatus is introduced into the seawater lithium extraction apparatus as a raw material for a seawater lithium extraction process.

### CROSS-REFERENCE TO RELATED APPLICATIONS

The application claims priority to Chinese patent application No. 2021116293500, filed on Dec. 28, 2021, the entire contents of which are incorporated herein by reference.

### TECHNICAL FIELD

The present application relates to the technical field of lithium extraction from concentrated seawater, in particular to a lithium extraction process that uses concentrated seawater as raw materials and realizes low energy cost through the coupling of a seawater desalination process of a thermal power plant and seawater lithium extraction.

### BACKGROUND

Lithium is one of the most important mineral resources in modern society and is widely used in the ceramic chemical, pharmaceutical and nuclear industries as well as in the widely known lithium-ion battery industry. With the popularity of electric vehicles and portable electronic devices, the scale of the lithium-ion battery market has risen dramatically, and it is expected to consume ⅓ of the current global minable lithium reserves in the next 30 years, which will lead to a shortage problem of lithium resource supply in the future. Currently, all of the world's minable lithium reserves come from ores and brines, totaling about 14 million tons. Extracting lithium salts from ores and brines consumes a lot of energy and causes serious pollution problems. Compared to the limited lithium resources in ores and brines on land, seawater contains 230 billion tons of lithium resources, which is 16,000 times the total amount of minable lithium resources in the world. Therefore, if the easy, controlled and clean extraction of lithium from seawater is realized, mankind will have almost inexhaustible lithium resources.

Many thermal power plants at home and abroad built on the seashores use a seawater desalination technology for their power plant water, which produces a large amount of concentrated seawater waste liquid after seawater desalination every year, which is directly discharged into the surrounding sea areas, and if this discharge continues, it will lead to the accumulation of salts in the local sea areas, which will have adverse consequences for the marine environment.

If the concentrated seawater discharged after seawater desalination can be utilized as raw materials, from which lithium can be extracted as raw materials for the future battery industry, it will greatly solve the shortage problem of global lithium ores.

### SUMMARY

The present application is intended to at least solve one of the technical problems in the related art to a certain degree.

Therefore, the present application aims to provide a thermal power plant seawater desalination and lithium extraction system, the lithium extraction system is combined with a seawater desalination process, and by using tail water of the seawater desalination process, i.e., concentrated seawater, as a raw material, circular economy of seawater desalination and seawater lithium extraction is achieved.

In order to achieve the above objective, the thermal power plant seawater desalination and lithium extraction system provided by the present application includes a seawater desalination apparatus and a seawater lithium extraction apparatus;
the seawater desalination apparatus is connected to a power supply of a thermal power plant or a peak load and frequency regulation power supply line, so that the seawater desalination apparatus is supplied with power through surplus power of the thermal power plant;
the seawater desalination apparatus is connected to a turbine extraction steam system of the thermal power plant, so that heat is supplied to the seawater desalination apparatus through the turbine extraction steam system;
the seawater lithium extraction apparatus is connected to the seawater desalination apparatus, so that concentrated seawater generated in a process of desalinating seawater by the seawater desalination apparatus is introduced into the seawater lithium extraction apparatus as a raw material for a seawater lithium extraction process; and
the seawater lithium extraction apparatus is connected to the power supply of the thermal power plant or the peak load and frequency regulation power supply line, so that the seawater lithium extraction apparatus is supplied with power through the power supply of the thermal power plant or the peak load and frequency regulation power supply line, and a production capacity load of the seawater lithium extraction apparatus changes to generate a variable power load so as to respond to demands for peak load and frequency regulation auxiliary services of the thermal power plant and a power grid.

Further, the seawater lithium extraction apparatus employs any one or a combination of an evaporative crystallization method, a sedimentation method, an adsorption method, a dialysis method and an electrochemical method in the lithium extraction process.

Further, a seawater desalination process adopted by the seawater desalination apparatus in the process of desalinating the seawater is any one of a multi-stage flash process, a power plant waste heat evaporation process, an electric heating evaporation process, and an electric drive multi-stage membrane process.

Further, an evaporation process of the evaporative crystallization method employs any one of a natural air-drying method of a natural salt making plant, or an electric heating or industrial waste heat heating method.

Further, a high alkaline solution used in the sedimentation method utilizes a high alkaline solution produced by electrolysis of seawater or electrolysis of brine.

Further, a process of removing calcium and magnesium ions from concentrated seawater, which is the raw material in the sedimentation method, is as follows: introducing flue gas produced by a fuel boiler of the thermal power plant into the concentrated seawater, and carbon dioxide in the flue gas reacting with the calcium and magnesium ions in the concentrated seawater to produce sediment to realize the removal of the calcium and magnesium ions.

Further, the dialysis method is an electrodialysis method, and peak load and frequency regulation surplus power or plant power of the thermal power plant is utilized to satisfy a power demand of the seawater lithium extraction process by the electrodialysis method.

A thermal power plant seawater desalination and lithium extraction method includes the following operation steps:
S1: planning and designing a capacity and scale of a seawater lithium extraction apparatus and a technical route thereof according to production capacity of a seawater desalination apparatus of a thermal power plant located at a seashore and a concentration, composition and flow rate of waste concentrated seawater produced every day;
S2: the seawater lithium extraction apparatus satisfying stable power supply for the seawater lithium extraction apparatus by using peak load and frequency regulation power or plant power supply of the thermal power plant, and generating a variable power load by using change of a production capacity load of the seawater lithium extraction apparatus, so as to respond to demands for peak load and frequency regulation auxiliary services of the thermal power plant and a power grid;
S3: the seawater lithium extraction apparatus achieving a process of taking concentrated seawater discharged from the seawater desalination apparatus as a raw material to prepare lithium by using an electrodialysis method or electrochemical method process; and
S4: the seawater desalination apparatus satisfying power and heat demands for a seawater desalination process by using surplus power and heat supply of the thermal power plant.

### The Present Application has the Beneficial Effects

1) the thermal power plant is coupled with the seawater desalination process to achieve seawater desalination with low energy cost.
2) The use of waste concentrated seawater produced by seawater desalination not only can solve the problem of salt concentration accumulation caused by discharging concentrated seawater into the sea, but also can obtain the raw material for the seawater lithium extraction process at the lowest cost.
3) Power consumption of the seawater lithium extraction apparatus, especially an electrodialysis apparatus or an electrochemical lithium extraction apparatus, is the main reason why the seawater lithium extraction apparatus cannot achieve large-scale industrialization, and if the peak load and frequency regulation of the thermal power plant or the power grid can be combined, large-scale lithium extraction can be achieved at the low cost.
4) The lithium extraction system of the present application is combined with the seawater desalination process, and by using tail water of the seawater desalination process, i.e., the concentrated seawater, as the raw material, circular economy of seawater desalination and seawater lithium extraction is achieved.

Additional aspects and advantages of the present application will be partially given in the following description, and partially become apparent in the following description, or will be learned by practice of the present application.

### BRIEF DESCRIPTION OF DRAWINGS

The above and/or additional aspects and advantages of the present application will become apparent and readily appreciated from the following description of the embodiments, taken in conjunction with the accompanying drawings.

FIG. 1 is a schematic structural diagram of a thermal power plant seawater desalination and lithium extraction system provided by an embodiment of the present application.

FIG. 2 is a schematic structural diagram of a thermal power plant seawater desalination and lithium extraction system in a different lithium extraction method of the present application.

FIG. 3 is a schematic structural diagram of a thermal power plant seawater desalination and lithium extraction system in a different lithium extraction method of the present application.

FIG. 4 is a schematic structural diagram of a thermal power plant seawater desalination and lithium extraction system in preparation of a lithium carbonate product of the present application.

FIG. 5 is a schematic structural diagram of a thermal power plant seawater desalination and lithium extraction system in a different desalination process and lithium extraction method of the present application.

FIG. 6 is a flowchart of a thermal power plant seawater desalination and lithium extraction method provided by another embodiment of the present application.

In the figures, 1, Seawater desalination apparatus; 2, Seawater lithium extraction apparatus; 3, Thermal power plant; 4, Peak load and frequency regulation control module; 5, Lithium carbonate sedimentation tank; and 6, Hydrogen or chlorine tank.

### DETAILED DESCRIPTION OF THE INVENTION

The embodiments of the present application will be described below in detail, examples of which are illustrated in the accompanying drawings. The same or similar reference numerals refer to the same or similar elements or elements having the same or similar functions throughout. The embodiments described below with reference to the accompanying drawings are exemplary, are merely used to explain the present application and cannot be construed as limiting the present application. Rather, the embodiments of the present application include all changes, modifications, and equivalents that fall within the spirit and connotation of the appended claims.

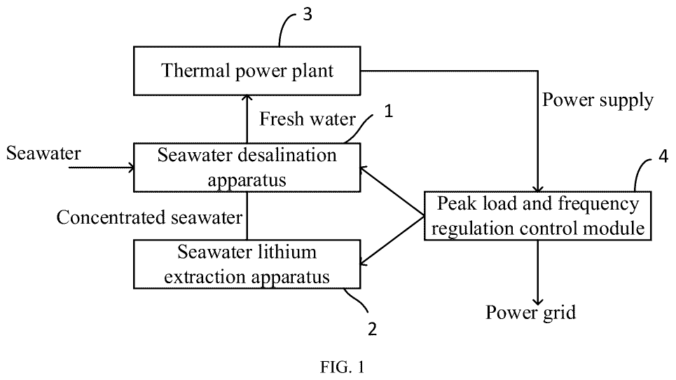

FIG. 1 is a schematic structural diagram of a thermal power plant seawater desalination and lithium extraction system provided by an embodiment of the present application.

Referring to FIG. 1, a thermal power plant seawater desalination and lithium extraction system includes a seawater desalination apparatus 1 and a seawater lithium extraction apparatus 2. The seawater desalination apparatus 1 is connected to a power supply of a thermal power plant 3 or a peak load and frequency regulation power supply line, so that the seawater desalination apparatus 1 is supplied with power through surplus power of the thermal power plant, that is to say, the seawater desalination apparatus 1 is connected to a peak load and frequency regulation control module 4, so that the peak load and frequency regulation control module 4 supplies the seawater desalination apparatus 1 with the surplus power of the thermal power plant. The seawater desalination apparatus 1 is connected to a turbine extraction steam system of the thermal power plant 3, so that heat is supplied to the seawater desalination apparatus 1 through the turbine extraction steam system, and seawater desalinated by the seawater desalination apparatus 1 is used in a power generation process of the thermal power plant. The seawater lithium extraction apparatus 2 is connected to the seawater desalination apparatus 1, so that concentrated seawater generated in a process of desalinating seawater by the seawater desalination apparatus 1 is introduced into the seawater lithium extraction apparatus 2 as a raw material for a seawater lithium extraction process, so that seawater desalination is achieved, and waste concentrated seawater generated in the desalination process can also be recovered without additionally providing concentrated seawater as the raw material needed by the seawater lithium extraction apparatus in the lithium extraction process, thereby improving the resource utilization rate and reducing the cost. The seawater lithium extraction apparatus 2 is connected to the power supply of the thermal power plant 3 or the peak load and frequency regulation power supply line, so that the seawater lithium extraction apparatus 2 is supplied with power through the power supply of the thermal power plant 3 or the peak load and frequency regulation power supply line, and a production capacity load of the seawater lithium extraction apparatus 2 changes to generate a variable power load so as to respond to demands for peak load and frequency regulation auxiliary services of the thermal power plant 3 and a power grid.

In detail, a water inlet of the seawater desalination apparatus 1 is connected to a water inlet pipe, the water inlet pipe is provided with a hydraulic pump, the hydraulic pump can pump seawater through the water inlet pipe into the seawater desalination apparatus 1, desalination of seawater is carried out in the seawater desalination apparatus 1, and the desalinated fresh water can be used in the power generation process of the thermal power plant 3. In addition, wasted concentrated brine generated in the desalination process can be directly introduced into the seawater lithium extraction apparatus 2 for seawater lithium extraction, which not only solves the problem of salt concentration accumulation caused by discharging concentrated seawater into the sea, but also obtains the raw material for the seawater lithium extraction process at the lowest cost.

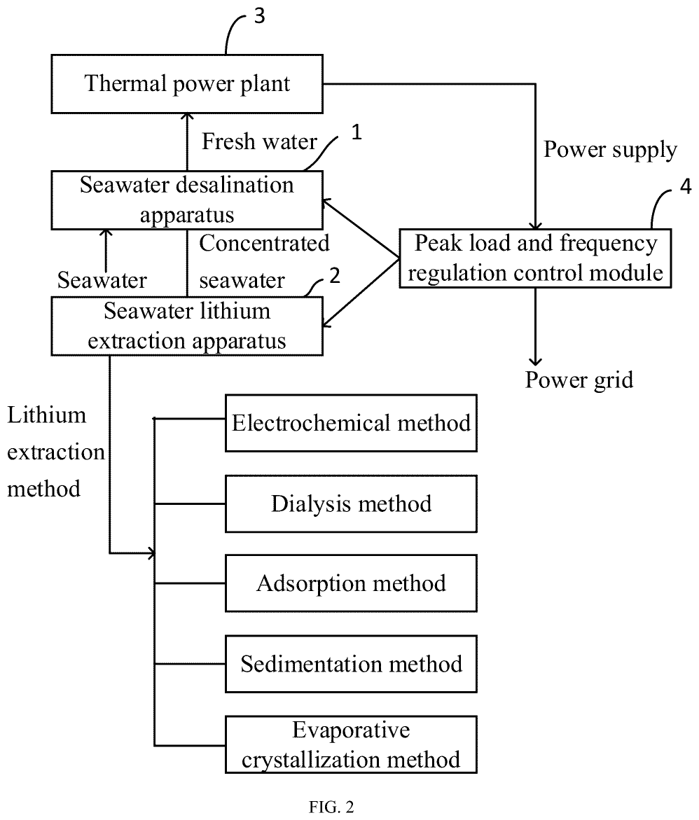

Referring to FIG. 2, in some embodiments, the seawater lithium extraction apparatus 2 employs any one or a combination of an evaporative crystallization method, a sedimentation method, an adsorption method, a dialysis method and an electrochemical method in the lithium extraction process, that is to say, seawater lithium extraction can be performed by means of any one of the evaporative crystallization method, the sedimentation method, the adsorption method, the dialysis method and the electrochemical method, or a combination of any of the above methods. It should be noted that seawater lithium extraction performed by any one of the evaporative crystallization method, the sedimentation method, the adsorption method, the dialysis method and the electrochemical method is the prior art, and will not be described in detail here.

In some embodiments, an evaporation process of the evaporative crystallization method employs any one of a natural air-drying method of a natural salt making plant, or an electric heating or industrial waste heat heating method.

It should be noted in detail that the sedimentation method usually involves the addition of a lye for a sedimentation reaction in the sedimentation process, where a high alkaline solution used in the sedimentation method may be a high alkaline solution produced by electrolysis of seawater or electrolysis of brine.

In addition, a process of removing calcium and magnesium ions from concentrated seawater, which is the raw material in the sedimentation method, is as follows: introducing flue gas produced by a fuel boiler of the thermal power plant into the concentrated seawater, and carbon dioxide in the flue gas reacting with calcium and magnesium ions in the concentrated seawater to produce sediment to realize the removal of the calcium and magnesium ions.

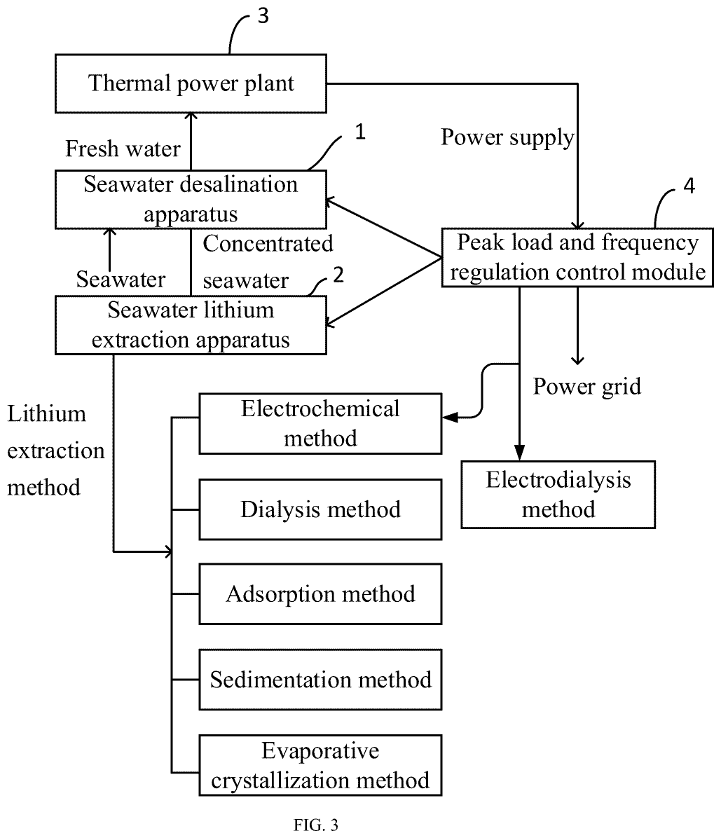

Referring to FIG. 3, in some embodiments, the dialysis method is an electrodialysis method, and peak load and frequency regulation surplus power or plant power of the thermal power plant 3 is utilized to satisfy a power demand of the seawater lithium extraction process by the electrodialysis method. In addition, power supply in the lithium extraction process of the electrochemical method also uses the peak load and frequency regulation surplus power or plant power of the thermal power plant.

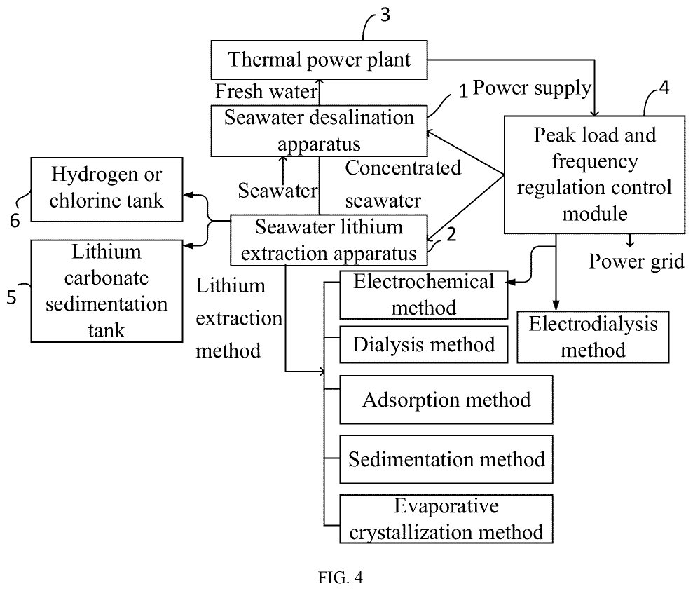

Referring to FIG. 4, in some embodiments, a lithium-rich liquid is obtained in the lithium extraction process of the lithium extraction apparatus, a finished lithium carbonate product is usually used, and therefore, in order to prepare the finished lithium carbonate product, a lithium carbonate sedimentation tank 5 is further included. The lithium carbonate sedimentation tank 5 is connected to the seawater lithium extraction apparatus 2 to receive the lithium-rich liquid produced by the lithium extraction apparatus 2, and the lithium-rich liquid reacts with a high alkaline solution that is introduced into the lithium carbonate sedimentation tank 5 to produce lithium carbonate. In addition, an ancillary product hydrogen or chlorine generated in the lithium extraction process is stored through a hydrogen or chlorine tank 6.

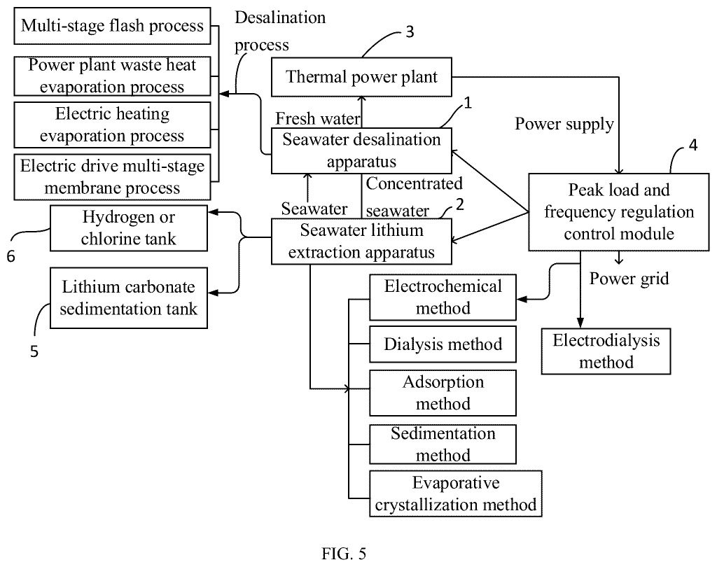

Referring to FIG. 5, in some embodiments, a seawater desalination process adopted by the seawater desalination apparatus 1 in the process of desalinating the seawater is any one of a multi-stage flash process, a power plant waste heat evaporation process, an electric heating evaporation process, and an electric drive multi-stage membrane process.

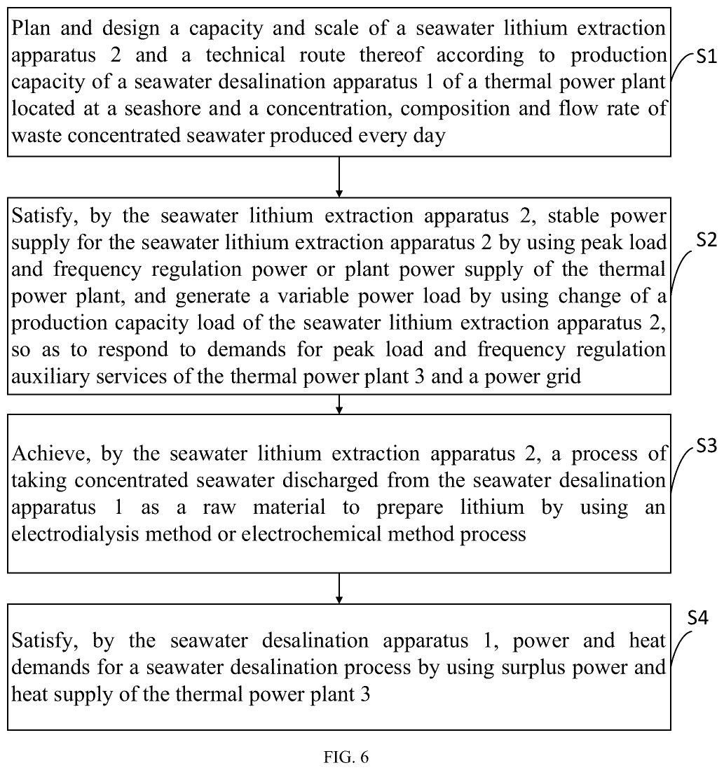

Referring to FIG. 6, in some embodiments, a thermal power plant seawater desalination and lithium extraction method includes the following operation steps:
S1: a capacity and scale of a seawater lithium extraction apparatus 2 and a technical route thereof are planned and designed according to production capacity of a seawater desalination apparatus 1 of a thermal power plant located at a seashore and a concentration, composition and flow rate of waste concentrated seawater produced every day;
S2: the seawater lithium extraction apparatus 2 satisfies stable power supply for the seawater lithium extraction apparatus 2 by using peak load and frequency regulation power or plant power supply of the thermal power plant, and generates a variable power load by using change of a production capacity load of the seawater lithium extraction apparatus 2, so as to respond to demands for peak load and frequency regulation auxiliary services of the thermal power plant 3 and a power grid;
S3: the seawater lithium extraction apparatus 2 achieves a process of taking concentrated seawater discharged from the seawater desalination apparatus 1 as a raw material to prepare lithium by using any one or a combination of an evaporative crystallization method, a sedimentation method, an adsorption method, a dialysis method and an electrochemical method, and preferably, lithium extraction is performed by means of an electrodialysis method or electrochemical method process; and
S4: preferably, the seawater desalination apparatus 1 satisfies power and heat demands for a seawater desalination process by using surplus power and heat supply of the thermal power plant 3.

In should be noted that in the description of the present application, the terms “first”, “second”, etc. are used for descriptive purposes only and are not to be construed as indicating or implying relative importance. In addition, in the description of the present application, unless otherwise indicated, “a plurality of” means two or more.

Any process or method described in the flowchart or otherwise described herein may be understood to represent a module, fragment, or portion that includes codes of one or more executable instructions for implementing the steps of a customized logic function or process, and the scope of the preferred implementations of the present application includes additional implementations, which may be implemented out of the order shown or discussed, including performing functions in a substantially simultaneous manner or in reverse order according to the functions involved, as should be understood by those skilled in the art to which the embodiments of the present application belong.

In the description of this specification, reference to the description of the terms “one embodiment”, “some embodiments”, “example”, “specific example”, or “some examples”, etc. means that the specific features, structures, materials, or characteristics described in connection with the embodiment or example are included in at least one embodiment or example of the present application. In this specification, schematic representations of the above terms do not necessarily refer to the same embodiments or examples. Furthermore, the specific features, structures, materials, or characteristics described may be combined in a suitable manner in any one or more embodiments or examples.

Although the embodiments of the present application have been shown and described above, it can be understood that the above embodiments are illustrative and cannot be construed as restrictive to the present application, and that changes, modifications, substitutions and variations can be made on the above embodiments by those ordinarily skilled in the art within the range of the present application.

What is claimed is:

1. A thermal power plant seawater desalination and lithium extraction system, comprising a seawater desalination apparatus and a seawater lithium extraction apparatus; wherein
the seawater desalination apparatus is connected to a power supply of a thermal power plant or a peak load and frequency regulation power supply line, so that the seawater desalination apparatus is supplied with power through surplus power of the thermal power plant;
the seawater desalination apparatus is connected to a turbine extraction steam system of the thermal power plant, so that heat is supplied to the seawater desalination apparatus through the turbine extraction steam system;
the seawater lithium extraction apparatus is connected to the seawater desalination apparatus, so that concentrated seawater generated in a process of desalinating seawater by the seawater desalination apparatus is introduced into the seawater lithium extraction apparatus as a raw material for a seawater lithium extraction process;
the seawater lithium extraction apparatus is connected to the power supply of the thermal power plant or the peak load and frequency regulation power supply line, so that the seawater lithium extraction apparatus is supplied with power through the power supply of the thermal power plant or the peak load and frequency regulation power supply line, and a production capacity load of the seawater lithium extraction apparatus changes to generate a variable power load so as to respond to demands for peak load and frequency regulation auxiliary services of the thermal power plant and a power grid;
the seawater lithium extraction apparatus employs any one or a combination of an evaporative crystallization method, a sedimentation method, an adsorption method, a dialysis method and an electrochemical method in the lithium extraction process;
a high alkaline solution used in the sedimentation method utilizes a high alkaline solution produced by electrolysis of seawater or electrolysis of brine, and a process of removing calcium and magnesium ions from concentrated seawater, which is the raw material in the sedimentation method, is as follows: introducing flue gas produced by a fuel boiler of the thermal power plant into the concentrated seawater, and carbon dioxide in the flue gas reacting with the calcium and magnesium ions in the concentrated seawater to produce sediment to achieve the removal of the calcium and magnesium ions; and
a seawater desalination process adopted by the seawater desalination apparatus in the process of desalinating the seawater is any one of a multi-stage flash process, a power plant waste heat evaporation process, an electric heating evaporation process, and an electric drive multi-stage membrane process.

2. The thermal power plant seawater desalination and lithium extraction system according to claim 1, wherein an evaporation process of the evaporative crystallization method employs any one of a natural air-drying method of a natural salt making plant, or an electric heating or industrial waste heat heating method.

3. The thermal power plant seawater desalination and lithium extraction system according to claim 1, wherein the dialysis method is an electrodialysis method, and peak load and frequency regulation surplus power or plant power of the thermal power plant is utilized to satisfy a power demand of the seawater lithium extraction process by the electrodialysis method.

4. A seawater desalination and lithium extraction method based on the thermal power plant seawater desalination and lithium extraction system according to any one of claims 1-3, comprising the following operation steps:
S1: planning and designing a capacity and scale of a seawater lithium extraction apparatus and a technical route thereof according to production capacity of a seawater desalination apparatus of a thermal power plant located at a seashore and a concentration, composition and flow rate of waste concentrated seawater produced every day;
S2: satisfying, by the seawater lithium extraction apparatus, stable power supply for the seawater lithium extraction apparatus by using peak load and frequency regulation power or plant power supply of the thermal power plant, and generating a variable power load by using change of a production capacity load of the seawater lithium extraction apparatus, so as to respond to demands for peak load and frequency regulation auxiliary services of the thermal power plant and a power grid;
S3: achieving, by the seawater lithium extraction apparatus, a process of taking concentrated seawater discharged from the seawater desalination apparatus as a raw material to prepare lithium by using an electrodialysis method or electrochemical method process; and
S4: satisfying, by the seawater desalination apparatus, power and heat demands for a seawater desalination process by using surplus power and heat supply of the thermal power plant.
